(19) United States
(12) Patent Application Publication
(10) Pub. No.: US 2009/0302740 A1
(43) Pub. Date: Dec. 10, 2009

(54) Fluorescent light bulb and manufacturing method thereof

(75) Inventors: Baogui Ge, Jiashan (CN); Wei Ge, Jiashan (CN)

Correspondence Address: DAVID AND RAYMOND PATENT FIRM, 108 N. YNEZ AVE., SUITE 128, MONTEREY PARK, CA, 91754, US

(73) Assignee: Boss Super Energy saving Lighting Incorporation Co., Ltd.

(21) Appl. No.: 12/157,410

(22) Filed: Jun. 9, 2008

(51) Int. Cl. H01J 63/04; H01J 9/02

(52) U.S. Cl. 313/485; 445/26

(57) ABSTRACT

A method of manufacturing a fluorescent light bulb includes the steps of: (a) providing a lighting base which has a plurality of electrical terminals formed thereon; (b) bending an elongated fluorescent tube to form a lower vertical-extending portion and an upper curving portion outwardly and radially extended from the vertical-extending portion; (c) communicatively linking every two of the fluorescent tubes to form a plurality of fluorescent elements, wherein a light passageway is formed between the two curving portions of the fluorescent tubes of each of the fluorescent elements; (d) mounting the fluorescent elements at the lighting base; and (e) electrically coupling the fluorescent elements with the lighting base, so as to allow the fluorescent light from the opposed fluorescent element to pass through the light passageway so as to enhance a brightness and efficiency of the fluorescent elements.

### BACKGROUND OF THE PRESENT INVENTION

1. Field of Invention

The present invention relates to a light bulb, and more particularly to a fluorescent light bulb and the manufacturing method thereof, wherein the fluorescent light bulb is capable of delivering illumination with enhanced brightness and increased efficiency.

2. Description of Related Arts

A conventional fluorescent light bulb usually comprises a supporting base and a fluorescent light tube mounted on top of the supporting base, wherein the supporting base is arranged to electrically connect to a power source for electrically activating the fluorescent light tube to generate illumination.

There are several disadvantages regarding this type of conventional fluorescent light bulb. First, as a matter of conventional art, most of the fluorescent light tube is made to extend on the supporting base in a spiral manner. While this design may maximize the surface area from which illumination can be delivered, there exists substantial loss of illumination (i.e. brightness) from the fluorescent light tube because an inner side of the spirally extending fluorescent light tube is not exposed to the ambient environment. This happens because when the fluorescent light tube is activated, the entire light tube is arranged to generate illumination, yet only those portion (i.e. outer side) of the fluorescent light tube which faces toward the ambient environment is capable of providing illumination to that ambient environment. There is no reflector of some sorts to direct that portion of light traveling toward an inner side (with respective to the supporting base) of the fluorescent light bulb back to the ambient environment. As a result, light is substantially blocked at the inner of the fluorescent light tube which constitutes substantial waste of energy and unsatisfactory performance of the fluorescent light bulb as a whole.

Moreover, when the fluorescent light tube is made in a spirally extending manner, the manufacturing process of the fluorescent light bulb is inherently complicated. As a matter of fact, there exist some fluorescent light tubes which are not spiral in shape, yet they are usually crowdedly packed on the supporting housing. The reason of this kind of design may be due to the fact that a single U-shaped fluorescent light tube is unable to produce sufficient illumination. As a result, the manufacturers put a plurality of elongated fluorescent light tubes having U-shaped or other cross sections on the supporting base. The problem with this kind of design is that the fluorescent light tubes are so crowdedly packed that a substantial amount of illumination is blocked at the inner side of the supporting base in a similar manner as described above.

### SUMMARY OF THE PRESENT INVENTION

A main object of the present invention is to provide a method of manufacturing a fluorescent light bulb wherein the fluorescent light bulb is capable of delivering illumination with enhanced brightness and increased efficiency.

Another object of the present invention is to provide a method of manufacturing a fluorescent light bulb comprising a plurality of elongated fluorescent elements spacedly mounted on a lighting base, in such a manner that the light blocked by an inner side of each of the elongated fluorescent elements are minimized so as to maximize an efficiency and effectiveness of light generation by the fluorescent light bulb.

Another object of the present invention is to provide a method of manufacturing a fluorescent light bulb which utilizes a minimum number of elongated fluorescent elements for a given brightness. In other words, the present invention simplifies the conventional manufacturing methods and the structure of conventional fluorescent light bulbs.

Another object of the present invention is to provide a method of manufacturing a fluorescent light bulb which is simple and convenient so as to allow a user of the present invention to manufacture the fluorescent light bulb with minimum cost and labor.

Accordingly, in order to accomplish the above objects, the present invention provides a fluorescent light bulb, comprising:

a lighting base having a plurality of electrical terminals; and

a fluorescent illuminating structure which comprises at least two fluorescent terminals electrically coupling with the electrical terminals and a plurality of fluorescent elements spacedly, upwardly and radially extended from the lighting base to define a light passage cavity within the fluorescent elements, wherein each of the fluorescent elements comprises two elongated fluorescent tubes filled with illuminating reactive agent and an communicating extension communicatively extended between the fluorescent tubes, wherein each of the fluorescent tubes has a lower vertical-extending portion extended from the lighting base and an upper curving portion outwardly and radially extended from the vertical-extending portion to define a light passageway between the two curving portions of the fluorescent tubes, such that when the fluorescent elements are electrified, each of the fluorescent tubes is adapted for generating fluorescent light at an outer surface thereof not only to increase a light projecting angle at the curving portion of each of the fluorescent tubes but also to allow the fluorescent light from the opposed fluorescent element passing through the light passageway so as to enhance a brightness and efficiency of the fluorescent illuminating structure, wherein the fluorescent illuminating structure is manufactured by a method comprising the steps of:

(a) bending each of the elongated fluorescent tubes into a predetermined shape to form the vertical-extending portion and the curving portion;

(b) filling the illuminating reactive agent into each of the fluorescent tubes to dispose the illuminating reactive agent onto an inner surface of the fluorescent tube;

(c) sealedly filling a predetermined amount of hydrogen gas and gaseous mercury into each of the fluorescent tubes; and

(d) mounting the fluorescent elements at the lighting base to electrically couple the fluorescent terminals with the electrical terminals.

Moreover, the present invention also provides a method of manufacturing a fluorescent light bulb, comprising the steps of:

(a) providing a lighting base which has a plurality of electrical terminals formed thereon;

(b) bending an elongated fluorescent tube to form a lower vertical-extending portion and an upper curving portion outwardly and radially extended from the vertical-extending portion, wherein each of the fluorescent tubes is filled with an illuminating reactive agent;

(c) communicatively linking every two of the fluorescent tubes to form a plurality of fluorescent elements, wherein a light passageway is formed between the two curving portions of the fluorescent tubes of each of the fluorescent elements;

(d) mounting the fluorescent elements at the lighting base at a position that the fluorescent elements are spacedly, upwardly and radially extended from the lighting base to define a light passage cavity within the fluorescent elements; and

(e) electrically coupling fluorescent terminals at the fluorescent elements with the electrical terminals of the lighting base, wherein when the fluorescent elements are electrified, each of the fluorescent tubes is adapted for generating fluorescent light at an outer surface thereof not only to increase a light projecting angle at the curving portion of each of the fluorescent tubes but also to allow the fluorescent light from the opposed fluorescent element passing through the light passageway so as to enhance a brightness and efficiency of the fluorescent elements.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fluorescent light bulb according to a preferred embodiment of the present invention.

FIG. 2 is a top view of the fluorescent light bulb according to the above preferred embodiment of the present invention.

FIG. 3 is a side view of the fluorescent light bulb according to the above preferred embodiment of the present invention.

FIG. 4 is a method of manufacturing a fluorescent illuminating structure according to the above preferred embodiment of the present invention.

FIG. 5 is a side view of a first alternative mode of the fluorescent light bulb according to the above preferred embodiment of the present invention.

FIG. 6 is a perspective view of the first alternative mode of the fluorescent light bulb according to the above preferred embodiment of the present invention.

FIG. 7 is a top view of the first alternative mode of the fluorescent light bulb according to the above preferred embodiment of the present invention.

FIG. 8 is another side view of the first alternative mode of the fluorescent light bulb according to the above preferred embodiment of the present invention.

FIG. 9 is a method of manufacturing a fluorescent light bulb according to the above preferred embodiment of the present invention.

### DETAILED DESCRIPTION OF THE PREFERRED EMBODIMENT

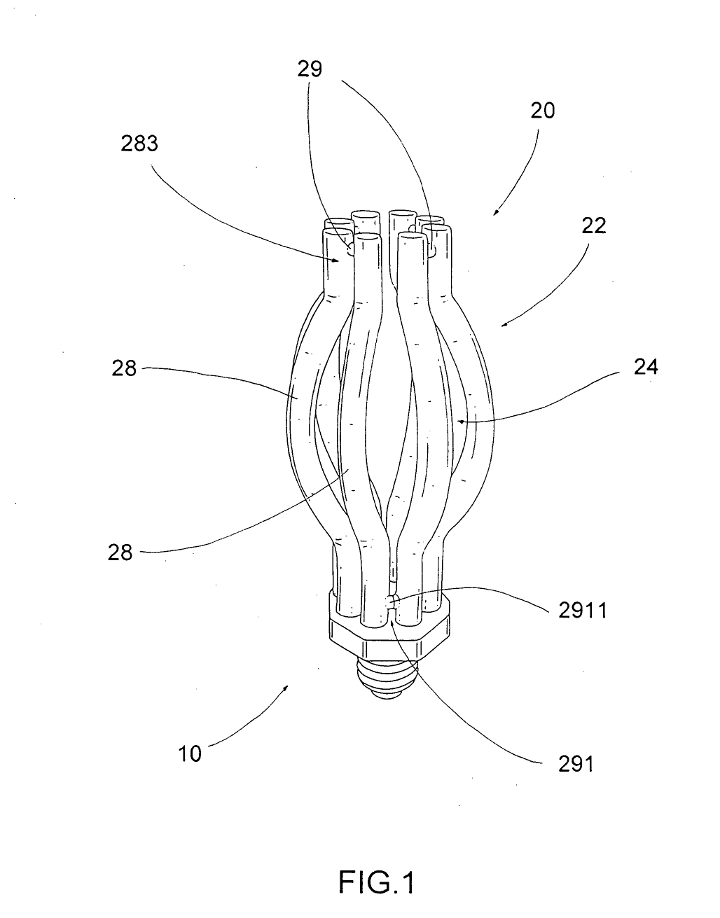

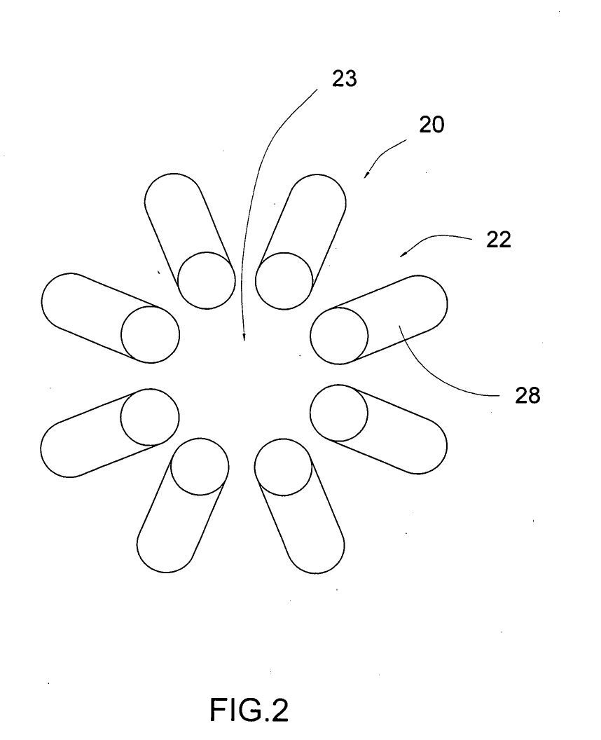

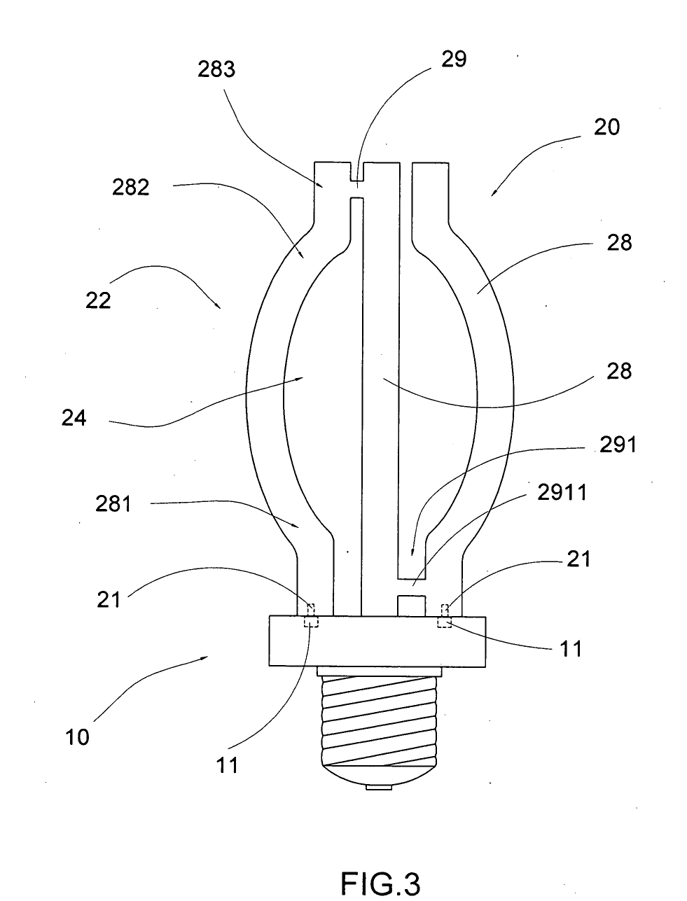

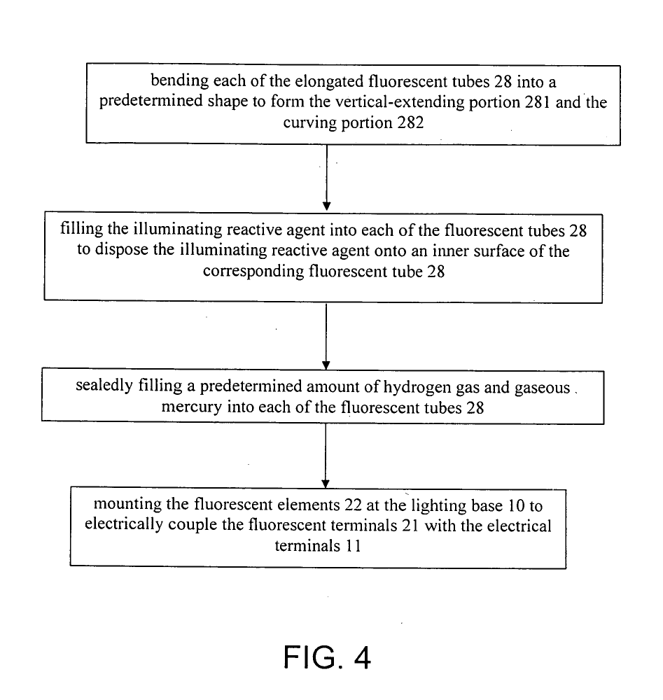

Referring to FIG. 1 to FIG. 4 of the drawings, a fluorescent light bulb and its manufacturing method according to a preferred embodiment of the present invention is illustrated, in which the fluorescent light bulb comprises a lighting base 10 and a fluorescent illuminating structure 20. As shown in the drawings, the lighting base 10 has a plurality of electrical terminals 11.

The fluorescent illuminating structure 20 comprises at least two fluorescent terminals 21 electrically coupling with the electrical terminals 11 and a plurality of elongated fluorescent elements 22 spacedly, upwardly and radially extended from the lighting base 10 to define a light passage cavity 23 within the fluorescent elements 22, wherein each of the fluorescent elements 22 comprises two elongated fluorescent tubes 28 filled with illuminating reactive agent and an communicating extension 29 communicatively extended between the fluorescent tubes 28, wherein each of the fluorescent tubes 28 has a lower vertical-extending portion 281 extended from the lighting base 10 and an upper curving portion 282 outwardly and radially extended from the lower vertical-extending portion 281 to define a light passageway 24 between the two curving portions 282 of the fluorescent tubes 28, such that when the fluorescent elements 22 are electrified, each of the fluorescent tubes 28 is adapted for generating fluorescent light at an outer surface thereof not only to increase a light projecting angle at the curving portion 282 of each of the fluorescent tubes 28 but also to allow the fluorescent light from the opposed fluorescent element 22 passing through the light passageway 24 so as to enhance a brightness and efficiency of the fluorescent illuminating structure 20, wherein the fluorescent illuminating structure 20 is manufactured by a method comprising the steps of:

(a) bending each of the elongated fluorescent tubes 28 into a predetermined shape to form the lower vertical-extending portion 281 and the curving portion 282;

(b) filling the illuminating reactive agent into each of the fluorescent tubes 28 to dispose the illuminating reactive agent onto an inner surface of the corresponding fluorescent tube 28;

(c) sealedly filling a predetermined amount of hydrogen gas and gaseous mercury into each of the fluorescent tubes 28; and

(d) mounting the fluorescent elements 22 at the lighting base 10 to electrically couple the fluorescent terminals 21 with the electrical terminals 11.

According to the preferred embodiment of the present invention, each of the communicating extensions 29 is transversely extended between two corresponding fluorescent tubes 28 to communicate the interiors of the corresponding fluorescent tubes 28.

Each of the fluorescent tubes 28 further has a top vertical-extending portion 283 integrally extended from the respective curving portion 282 to coaxially align with the lower vertical-extending portion 281, wherein the communicating extension 29 is communicatively linked between the top vertical-extending portions 283 of the two corresponding fluorescent tubes 28.

In step (b), the illuminating reactive agent is a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling florescent powder and 1000 ml of pure water.

Moreover, the fluorescent illuminating structure 20 further comprises a plurality of communication links 291 communicatively linking the fluorescent elements 22 with each other, wherein each of the communication links 291 comprises a tubular tunnel 2911 communicatively extended between one of the fluorescent tubes 28 of the fluorescent element 22 to another the fluorescent tube 28 of the neighboring fluorescent element 22.

Accordingly, the two fluorescent terminals 21 are provided at the two neighboring fluorescent tubes 28 of the fluorescent elements 22 such that the fluorescent elements 22 form a single light source for generating the fluorescent light when the fluorescent illuminating structure 20 is electrified.

As a slight alternative of this feature, the two fluorescent terminals 21 can also be provided at the two fluorescent tubes 28 of each of the fluorescent elements 22 such that the fluorescent elements form a multiple light source for generating the fluorescent light when the fluorescent illuminating structure 20 is electrified. In other words, each of the fluorescent elements 22 is separately powered to form the multiple light source of the fluorescent light bulb of the present invention.

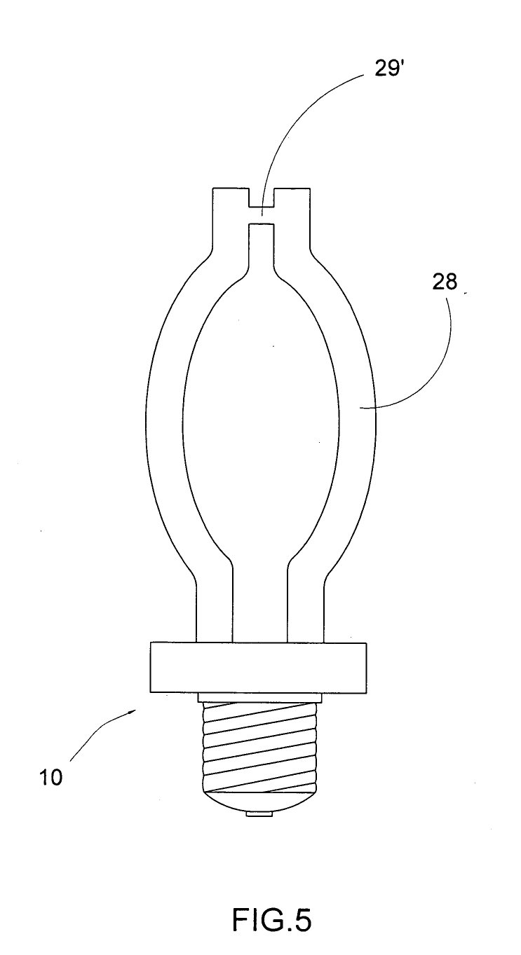

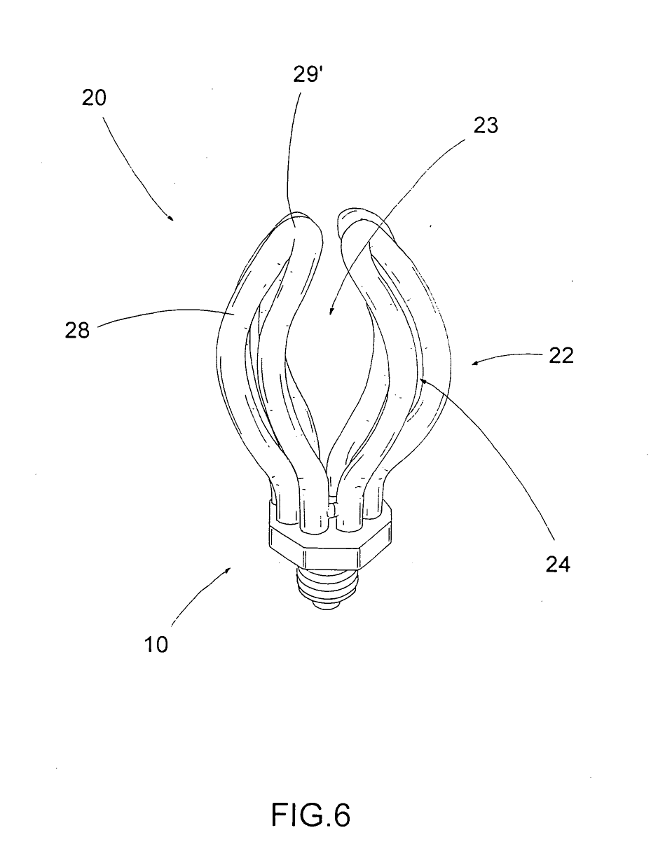

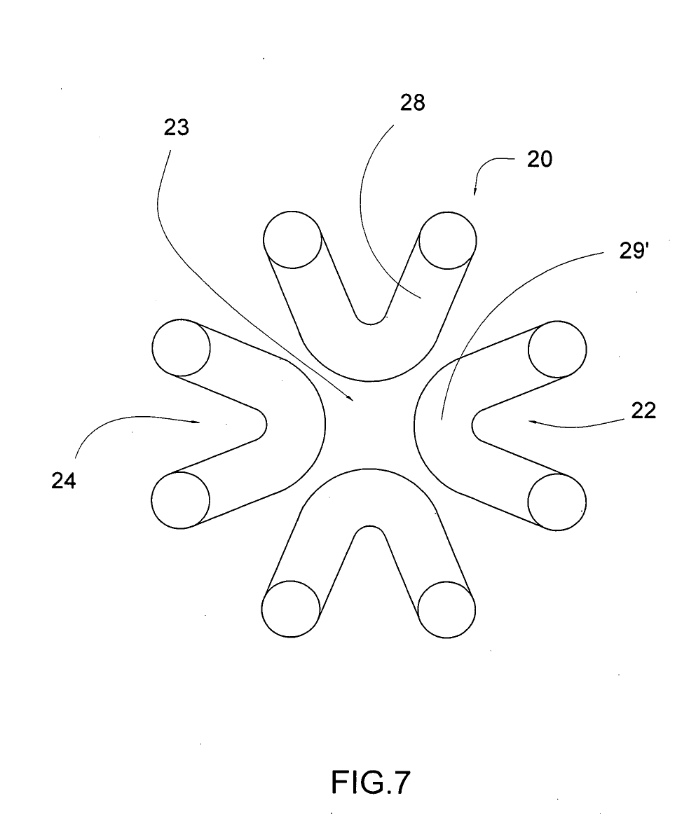

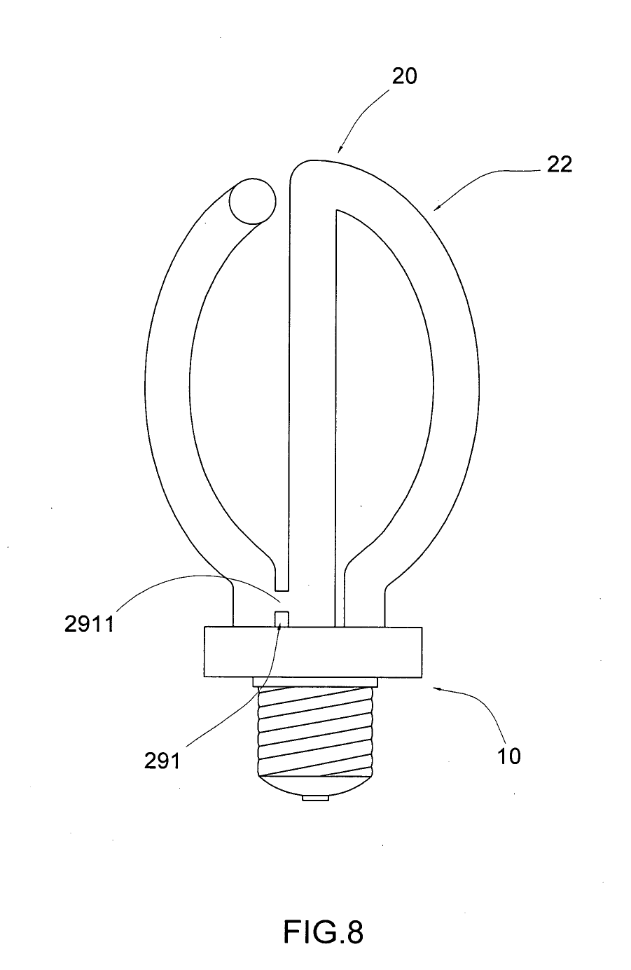

Referring to FIG. 5 to FIG. 8 of the drawings, a first alternative mode of the fluorescent light bulb according to the preferred embodiment of the present invention is illustrated. The first alternative mode is similar to the preferred embodiment, except that the communicating extension 29′ is integrally extended from two top ends of the fluorescent tubes 28 to form a V-shaped acute-angled tube pointing towards a center of the lighting base 10 so as to communicate interiors of the fluorescent tubes 28.

The operation of the present invention is as follows: the lighting base 10 is adapted for connecting to an external power source, so that when it is electrically connected, the fluorescent terminals 21 is activated to generate a proportional amount of heat. When the fluorescent terminals 21 are heated up to a predetermined elevated temperature (usually at 1160K), the fluorescent terminals 21 start releasing electrons to the hydrogen gas filled within the fluorescent tubes 28. Hydrogen atoms, upon being impacted by the fluorescent terminals electrons, will in turn hit mercury atoms. The mercury atoms trapped within the fluorescent tubes 28 will then generate ultraviolet radiation having a typical wavelength of approximately 253.7 nm. The ultraviolet radiation then initiates generation of illumination by the illuminating reactive agent.

It is worth mentioning that due to the geometrical feature of the fluorescent illuminating structure, the illumination generated by the individual elongated fluorescent elements 20 is not blocked by an inner side of the elongated fluorescent elements 20. Rather, the light generated by each of the fluorescent tubes 28 is capable of passing through the corresponding light passageways 24 for reaching the ambient environment. As a result, the fluorescent light bulb of the present invention is capable of producing illumination with maximum effectiveness and efficiency.

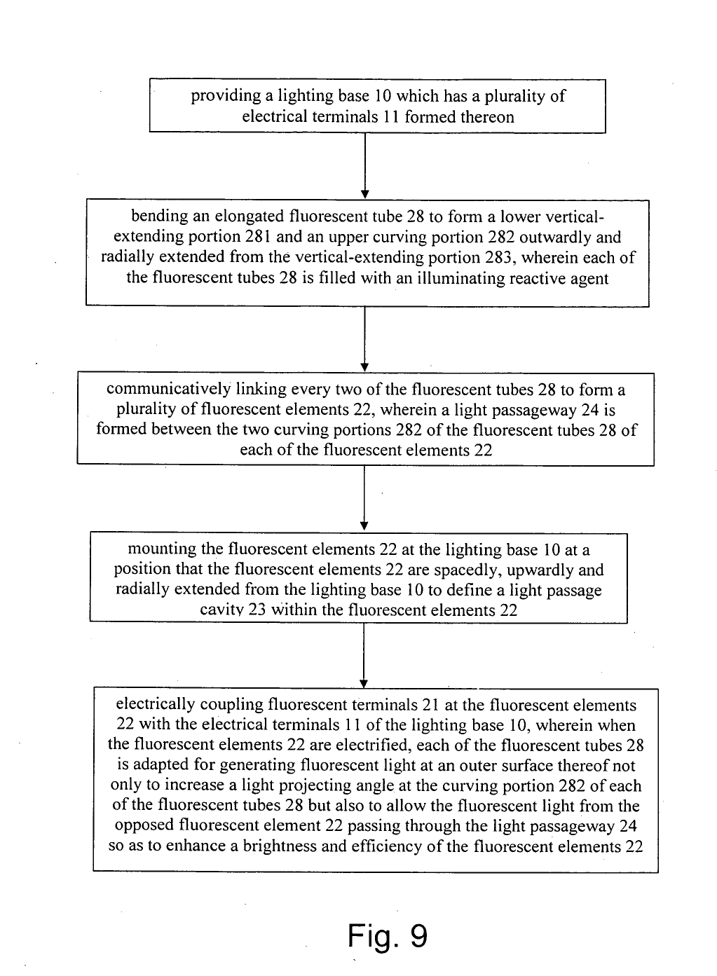

Referring to FIG. 9 of the drawings, a method of manufacturing a fluorescent light bulb according to the preferred embodiment of the present invention is illustrated, in which the method comprises the steps of:

(a) providing a lighting base 10 which has a plurality of electrical terminals 11 formed thereon;

(b) bending an elongated fluorescent tube 28 to form a lower vertical-extending portion 281 and an upper curving portion 282 outwardly and radially extended from the vertical-extending portion 283, wherein each of the fluorescent tubes 28 is filled with an illuminating reactive agent;

(c) communicatively linking every two of the fluorescent tubes 28 to form a plurality of fluorescent elements 22, wherein a light passageway 24 is formed between the two curving portions 282 of the fluorescent tubes 28 of each of the fluorescent elements 22;

(d) mounting the fluorescent elements 22 at the lighting base 10 at a position that the fluorescent elements 22 are spacedly, upwardly and radially extended from the lighting base 10 to define a light passage cavity 23 within the fluorescent elements 22; and

(e) electrically coupling fluorescent terminals 21 at the fluorescent elements 22 with the electrical terminals 11 of the lighting base 10, wherein when the fluorescent elements 22 are electrified, each of the fluorescent tubes 28 is adapted for generating fluorescent light at an outer surface thereof not only to increase a light projecting angle at the curving portion 282 of each of the fluorescent tubes 28 but also to allow the fluorescent light from the opposed fluorescent element 22 passing through the light passageway 24 so as to enhance a brightness and efficiency of the fluorescent elements 22.

Step (b) further comprises a step of bending each of the fluorescent tubes 28 to form a top vertical-extending portion 283 integrally extended from the curving portion 282 to coaxially align with the lower vertical-extending portion 281, wherein the communicating extension 29 is communicatively linked between the top vertical-extending portions 283 of the two corresponding fluorescent tubes 28.

Alternatively, step (c) further comprises a step of bending an elongated tube in half to form said two fluorescent tubes 28 alongside of each other and to form said communicating extension 29 at two top ends of said fluorescent tubes 28 as a V-shaped acute-angled tube pointing towards a center of said lighting base so as to communicate interiors of said fluorescent tubes 28.

It is worth mentioning that each of the fluorescent elements 22 can form a single light source or multiple light source (as described above) generating the fluorescent light when the corresponding fluorescent element 22 is electrified.

Moreover, each of the fluorescent tubes 28 is manufactured by a method comprising the steps of:

disposing the illuminating reactive agent onto an inner surface of each of the fluorescent tubes 28;

repeatedly heating the fluorescent tubes 28 from ambient temperature to approximately 550° C.; and

sealedly filling a predetermined amount of hydrogen gas and gaseous mercury into each of the fluorescent tubes 28.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fluorescent light bulb, comprising:
a lighting base having a plurality of electrical terminals; and
a fluorescent illuminating structure which comprises at least two fluorescent terminals electrically coupling with said electrical terminals and a plurality of fluorescent elements spacedly, upwardly and radially extended from said lighting base to define a light passage cavity within said fluorescent elements, wherein each of said fluorescent elements comprises two elongated fluorescent tubes filled with illuminating reactive agent and an communicating extension communicatively extended between said fluorescent tubes, wherein each of said fluorescent tubes has a lower vertical-extending portion extended from said lighting base and an upper curving portion outwardly and radially extended from said vertical-extending portion to define a light passageway between said two curving portions of said fluorescent tubes, such that when said fluorescent elements are electrified, each of said fluorescent tubes is adapted for generating fluorescent light at an outer surface thereof not only to increase a light projecting angle at said curving portion of each of said fluorescent tubes but also to allow said fluorescent light from said opposed fluorescent element passing through said light passageway so as to enhance a brightness and efficiency of said fluorescent illuminating structure, wherein said fluorescent illuminating structure is manufactured by a method comprising the steps of:
(a) bending each of said elongated fluorescent tubes into a predetermined shape to form said vertical-extending portion and said curving portion;
(b) filling said illuminating reactive agent into each of said fluorescent tubes to dispose said illuminating reactive agent onto an inner surface of said fluorescent tube;
(c) sealedly filling a predetermined amount of hydrogen gas and gaseous mercury into each of said fluorescent tubes; and
(d) mounting said fluorescent elements at said lighting base to electrically couple said fluorescent terminals with said electrical terminals.

2. The fluorescent light bulb, as recited in claim 1, wherein said communicating extension is integrally extended from two top ends of said fluorescent tubes to form a V-shaped acute-angled tube pointing towards a center of said lighting base so as to communicate interiors of said fluorescent tubes.

3. The fluorescent light bulb, as recited in claim 1, wherein said communicating extension is transversely extended between said fluorescent tubes to communicate interiors of said fluorescent tubes.

4. The fluorescent light bulb, as recited in claim 1, wherein each of said fluorescent tubes further has a top vertical-extending portion integrally extended from said curving portion to coaxially align with said lower vertical-extending portion, wherein said communicating extension is communicatively linked between said top vertical-extending portions of said two corresponding fluorescent tubes.

5. The fluorescent light bulb, as recited in claim 3, wherein each of said fluorescent tubes further has a top vertical-extending portion integrally extended from said curving portion to coaxially align with said lower vertical-extending portion, wherein said communicating extension is communicatively linked between said top vertical-extending portions of said two corresponding fluorescent tubes.

6. The fluorescent light bulb, as recited in claim 1, wherein said illuminating reactive agent comprises a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling fluorescent powder and 1000 ml of pure water.

7. The fluorescent light bulb, as recited in claim 2, wherein said illuminating reactive agent comprises a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling fluorescent powder and 1000 ml of pure water.

8. The fluorescent light bulb, as recited in claim 5, wherein said illuminating reactive agent comprises a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling fluorescent powder and 1000 ml of pure water.

9. The fluorescent light bulb, as recited in claim 1, wherein said fluorescent illuminating structure further comprises a plurality of communication links communicatively link said fluorescent elements with each other, wherein each of said communication links comprises a tubular tunnel communicatively extended between one of said fluorescent tubes of said fluorescent element to another said fluorescent tube of said neighboring fluorescent element.

10. The fluorescent light bulb, as recited in claim 2, wherein said fluorescent illuminating structure further comprises a plurality of communication links communicatively link said fluorescent elements with each other, wherein each of said communication links comprises a tubular tunnel communicatively extended between one of said fluorescent tubes of said fluorescent element to another said fluorescent tube of said neighboring fluorescent element.

11. The fluorescent light bulb, as recited in claim 5, wherein said fluorescent illuminating structure further comprises a plurality of communication links communicatively link said fluorescent elements with each other, wherein each of said communication links comprises a tubular tunnel communicatively extended between one of said fluorescent tubes of said fluorescent element to another said fluorescent tube of said neighboring fluorescent element.

12. The fluorescent light bulb, as recited in claim 9, wherein said two fluorescent terminals are provided at said two neighboring fluorescent tubes of said fluorescent elements such that said fluorescent elements form a single light source for generating said fluorescent light when said fluorescent illuminating structure is electrified.

13. The fluorescent light bulb, as recited in claim 10, wherein said two fluorescent terminals are provided at said two neighboring fluorescent tubes of said fluorescent elements such that said fluorescent elements form a single light source for generating said fluorescent light when said fluorescent illuminating structure is electrified.

14. The fluorescent light bulb, as recited in claim 11, wherein said two fluorescent terminals are provided at said two neighboring fluorescent tubes of said fluorescent elements such that said fluorescent elements form a single light source for generating said fluorescent light when said fluorescent illuminating structure is electrified.

15. The fluorescent light bulb, as recited in claim 1, wherein said two fluorescent terminals are provided at said two fluorescent tubes of each of said fluorescent elements such that said fluorescent elements form a multiple light source for generating said fluorescent light when said fluorescent illuminating structure is electrified.

16. The fluorescent light bulb, as recited in claim 2, wherein said two fluorescent terminals are provided at said two fluorescent tubes of each of said fluorescent elements such that said fluorescent elements form a multiple light source for generating said fluorescent light when said fluorescent illuminating structure is electrified.

17. The fluorescent light bulb, as recited in claim 5, wherein said two fluorescent terminals are provided at said two fluorescent tubes of each of said fluorescent elements such that said fluorescent elements form a multiple light source for generating said fluorescent light when said fluorescent illuminating structure is electrified.

18. A method of manufacturing a fluorescent light bulb, comprising the steps of:
(a) providing a lighting base which has a plurality of electrical terminals formed thereon;
(b) bending an elongated fluorescent tube to form a lower vertical-extending portion and an upper curving portion outwardly and radially extended from said vertical-extending portion, wherein each of said fluorescent tubes is filled with an illuminating reactive agent;
(c) communicatively linking every two of said fluorescent tubes to form a plurality of fluorescent elements, wherein a light passageway is formed between said two curving portions of said fluorescent tubes of each of said fluorescent elements;
(d) mounting said fluorescent elements at said lighting base at a position that said fluorescent elements are spacedly, upwardly and radially extended from said lighting base to define a light passage cavity within said fluorescent elements; and
(e) electrically coupling fluorescent terminals at said fluorescent elements with said electrical terminals of said lighting base, wherein when said fluorescent elements are electrified, each of said fluorescent tubes is adapted for generating fluorescent light at an outer surface thereof not only to increase a light projecting angle at said curving portion of each of said fluorescent tubes but also to allow said fluorescent light from said opposed fluorescent element passing through said light passageway so as to enhance a brightness and efficiency of said fluorescent elements.

19. The method, as recited in claim 18, wherein the step (c) further comprises a step of bending an elongated tube in half to form said two fluorescent tubes alongside of each other and to form said communicating extension at two top ends of said fluorescent tubes as a V-shaped acute-angled tube pointing towards a center of said lighting base so as to communicate interiors of said fluorescent tubes.

20. The method, as recited in claim 18, wherein the step (b) further comprises a step of bending each of said fluorescent tubes to form a top vertical-extending portion integrally extended from said curving portion to coaxially align with said lower vertical-extending portion, wherein said communicating extension is communicatively linked between said top vertical-extending portions of said two corresponding fluorescent tubes.

21. The method, as recited in claim 19, wherein each of said fluorescent elements is communicatively linked with each other such that said fluorescent elements form a single light source for generating said fluorescent light when one of said fluorescent elements is electrified.

22. The method, as recited in claim 20, wherein each of said fluorescent elements is communicatively linked with each other such that said fluorescent elements form a single light source for generating said fluorescent light when one of said fluorescent elements is electrified.

23. The method, as recited in claim 19, wherein each of said fluorescent elements forms a single light source generating said fluorescent light when said corresponding fluorescent element is electrified.

24. The method, as recited in claim 20, wherein each of said fluorescent elements forms a single light source generating said fluorescent light when said corresponding fluorescent element is electrified.

25. The method, as recited in claim 19, wherein said illuminating reactive agent comprises a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling fluorescent powder and 1000 ml of pure water.

26. The method, as recited in claim 20, wherein said illuminating reactive agent comprises a chemical mixture consisting of 860 ml of 12% aluminum oxide suspension, 60 ml of 1% defoamer, 9 ml dispersing agent, 1800 ml of 5% polyethylene oxide, 40 ml of momoethanolamine, 2 kg of free ball milling fluorescent powder and 1000 ml of pure water.

27. The method, as recited in claim 25, wherein said each of said fluorescent tubes is manufactured by a method comprising the steps of:
disposing said illuminating reactive agent onto an inner surface of each of said fluorescent tubes;
repeatedly heating said fluorescent tubes from ambient temperature to approximately 550° C.; and
sealedly filling a predetermined amount of hydrogen gas and gaseous mercury into each of said fluorescent tubes.

28. The method, as recited in claim 26, wherein said each of said fluorescent tubes is manufactured by a method comprising the steps of:
disposing said illuminating reactive agent onto an inner surface of each of said fluorescent tubes;
repeatedly heating said fluorescent tubes from ambient temperature to approximately 550° C.; and
sealedly filling a predetermined amount of hydrogen gas and gaseous mercury into each of said fluorescent tubes.
